(19) United States
(12) Patent Application Publication
(10) Pub. No.: US 2006/0259574 A1
(43) Pub. Date: Nov. 16, 2006

(54) Method and apparatus for accessing spatially associated information

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/315,755

(22) Filed: Dec. 21, 2005

Related U.S. Application Data
(60) Provisional application No. 60/680,699, filed on May 13, 2005.

(51) Int. Cl. G06F 15/16

(52) U.S. Cl. 709/217

(57) ABSTRACT

A targeting location information system uses a portable computing device interfaced with a positioning system in combination with a distributed network. Targeting methods and apparatus are then used to identify a user selected location that is some distance away from the then current location of the portable computing device, the targeting methods allow the user of said portable computing device to target a specific distant location or a range of specific distant locations that is a particular distance and orientation away from said then current location of the portable computing device. Target location coordinates for a specific or range of distant locations is then transmitted to the distributed network and is used in the retrieval of corresponding location specific information. Additional information may be associated with the web page information such as priority information, object type information, context type information, or weighting information. The web page information associated with said location coordinates may then be displayed, optionally contingent upon said priority information, context type information, object type information, or other conditional information.

This application claims the benefit of U.S. Provisional Application No. 60/680,699, filed May 13, 2005 which is incorporated in its entirety herein by reference.

### BACKGROUND

1. Field of the Invention

This invention relates generally to the field of information stored and accessed based upon geographic locations.

2. Discussion of the Related Art

Some basic ideas for information stored and accessed based upon geographic locations are described in the paper by Spohrer entitled Information in Places and published in IBM Systems Journal, vol. 38, No. 4, 1999 (p. 602-628) which is hereby incorporated by reference.

A number of systems have been developed for accessing location related information, said location related information being accessed based upon the then current location of said portable computing system as determined by one or more Global Positioning System (GPS) sensor local to a computing system. For example, U.S. Pat. No. 6,122,520 (2000) to Want, et. al. entitled “System and method for obtaining and using location specific information” and hereby incorporated by reference, describes a system that uses Navstar Global Positioning System (GPS), in combination with a distributed network, to access location related information based upon GPS coordinates. In addition U.S. Pat. No. 6,819,267 (2004) to Edmark, et. al. entitled “System and method for proximity bookmarks using GPS and pervasive computing” and hereby incorporated by reference, also describes a system for accessing location related information using GPS coordinates. In addition U.S. patent application No. 20050032528 (2005) to Dowling, et. al. entitled “Geographical web browser, methods, apparatus and systems” and hereby incorporated by reference, also describes a system for accessing location related information using GPS coordinates.

The problem with such systems is that a user often wants to gain information about a location that they are not local to, but which is off in the viewable distance to that user. For example, a user may be standing on a street corner and is looking at a building that is a few hundred yards away and may desire information about that building. Or a user may be standing in a park and is looking at a tree that is a hundred feet away and may desire information about that tree. Or a user may be standing on a hilltop vista looking at a lake that is two miles away and may desire information about that lake. In addition, the distant object that the user may desire information about may be near many other objects that also have information associated with them based upon their geographic location.

Many people travel about the world without realizing the wealth of information concerning their surroundings. For example, people travel in their own communities without knowing what buildings may be of historical significance or what shopping center may have a specific store or whether any store in the shopping center sells a specific product. In addition the natural world is abundant with location-related information that would be of interest to people—the names of particular trees, plants, landforms, bodies of water, and other natural landmarks that are fixed in location.

In many instances, people rely on maps, field guides, brochures or other literature in order to familiarize themselves with their surroundings. These documents may include tourist/travel brochures, shopping mail directories/maps, park field guides or naturalist books, or other similar literature. However, these documents are not very informative because they contain limited amounts of information and are generally not useful on the fine identification of objects such as specific trees and plants. Also such printed information is generally not kept up to date as well as on-line information.

This lack of information often results in ineffective advertising for businesses and limited scientific information about natural phenomenon. For example, on a traditional map or brochure covering a city, business are not be able to provide the consumer with a list of products sold in a particular store nor can businesses indicate products that are currently on sale or otherwise featured. On a traditional map or guide covering a park, information can not be given that identifies the type and age and factual information associated with individual trees. Similarly, a local historical building may not be able to provide the public with detailed historical information concerning the significance of the site.

However, many entities, such as stores, parks, historical sites, and/or businesses now utilize distributed networks, such as the Internet and, more particularly, the World Wide Web portion of the Internet, to provide the public with useful information. For example, information about a historical site, such as a Civil War battlefield, may be disseminated via the World Wide Web and accessed though commercial Internet service providers (ISPs). The World Wide Web also provides the public with countless amounts of other information, such as business data, stock quotes or official government information.

However, a user will not have access to the desired information unless they manually input a web address or uniform resource locator (URL) associated with a particular web page. In these cases, it may be difficult to retrieve the web page because the URL may be unknown and/or difficult to locate, even with the sophisticated search engines currently available. Also, the web address may be very long which may result in a mistake when entering the web address. Also, in many cases, the user may be at a location and looking at an object in the distance, such as a tree or building or river or lake or hill or valley or outcropping of rock; and may not know what kind of tree it is, what building it is, what the name or the river is, what the name of the lake is, how tall the hill is, what the name of valley is, or the composition of the outcropping of rock. All the user may know is that the object is located within their field of view, some distance away at a particular orientation. In such a circumstance the user may not know how to search for a URL that would provide information about the particular tree, building, river, lake, hill, rock, or other object that they are then looking at and wondering about.

As mentioned above, a number of systems have been developed to link a GPS location with factual information on the Internet such that the information can be retrieved by a user who is using a portable computing device interfaced with a GPS sensor by standing at a given location. While these systems provide certain important features they lack the ability to enable a user to identify a particular location (or object at a location) other than the location the user is standing at. This is a critical need because a user may not desire information about his or her current GPS location but rather may desire to identify a GPS location (or object at a location) that is some distance away in a particular direction. For example a user may be standing on a hilltop, looking a lake in the distance. That lake is not at the user's current GPS location, but at some other location in the distance.

What is clearly needed are methods and apparatus that allow a user to conveniently identify an object at a distance in a direction from the user and distinguish that object from other nearby objects and then retrieve information about that distant object.

3. Features and Advantages

A feature is to obtain information relating to an identified location using a positioning system interfaced to a portable computing device, said identified location being some distance away from the user's location.

Another feature relates to a system and methods for obtaining location specific information about a particular identified location that is a particular distance and orientation away from the location at which the user is currently standing using a distributed network in combination with a GPS enabled portable computing device, said system and method involving unique targeting, ranging, and prioritization methods and technology.

Another feature incorporates a scroll wheel by which a user can easily scroll and select particular identified locations on the portable computing device within the field of view of the portable computing device.

Another feature incorporates a laser range finder or ultrasonic range finder to determine the distance from the user to the particular identified locations.

Another feature incorporates an optical focusing sensor mechanism for selectively accessing information about objects at different distances from the user.

Another feature is to provide a user aiming portion of said portable computing device, the user aiming portion aimable by the user at a remote location.

Another feature incorporates a laser pointing within said user aiming portion to assist said user in aiming at a remote location when activated by a user.

Another feature incorporates a camera within said user aiming portion, said camera providing an image that assists said user in aiming said user aiming portion at a remote location.

Still further features and advantages will become apparent from a consideration of the ensuing description and drawings.

### SUMMARY OF THE INVENTION

Several embodiments of the invention advantageously address the needs above as well as other needs by providing methods and apparatus that allow the retrieval of information about objects located at a distance.

In one embodiment, the invention enables a user to access information associated with a distant spatial location by pointing a handheld computing device at a distant location. A portable computing device interfaced with a positioning system in combination with a distributed network, such as the Internet, provides real-time location specific information to a user. The location identifying method and apparatus is then used to identify a location that is some distance away from the portable computing device. The portable computing device then displays information about the distant location.

In another embodiment, the portable computing is pointed by the user at a distant point and multiple objects are targeted within a defined field of view. The range and scope of the field of view is controllable by the user.

Also, in another embodiment, the portable computing device is equipped with a finger controllable roller to provide easier manipulation of the various functions associated with the embodiment.

Yet, in another embodiment, a video camera is incorporated into the device to capture an image of the distant objects and allow the user to more easily aim the portable computing device a distant location. In some such embodiments a cross-hairs or other visual indicator is used upon the displayed camera image to further assist the user in aiming the portable computing device at a distant location.

Yet in another embodiment a laser pointer is incorporated into the device to capture an image of the distant objects and allow the user to more easily aim the portable computing device a distant location.

The portable computing device may exist in a number of user friendly configurations, such as a palm held device held by a single hand, or a configuration that uses two hands for added stability and ease of use.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a front view of the portable computing device configured with the hardware and software of an embodiment of the present invention.

FIG. 2 is a systems block diagram an embodiment of the present invention.

FIG. 3 is a front view of the portable computing device with a finger controllable roller.

FIG. 4 is a front view of the portable computing device pointed at a distant object by the user. Also shown is an integrated laser pointer for projecting a red dot upon objects that fall within the line-of-sight aiming direction of the portable computing device.

FIG. 5 is a front view of the portable computing device pointed at a distant object by the user. Also shown is an integrated laser pointer for projecting multiple red dots upon objects that fall within the line-of-sight aiming direction.

FIG. 6 is a front view of a portable computing device equipped with an integrated digital video camera aimed at a distant object. Also shown is a captured image of the distant objects by the portable computing device as aimed by the user.

FIG. 7 is a front view of an alternate configuration of a handheld portable computing device with a video camera attached. Also shown are user adjustable crosshairs on the display.

FIG. 8a and FIG. 8b respectively shows a virtual target line and a virtual target area extending from the portable computing device in the direction it is aimed by the user.

### DETAILED DESCRIPTION

The following description is not to be taken in a limiting sense, but is made merely for the purpose of describing the general principles of exemplary embodiments. The scope of the invention should be determined with reference to the claims.

Overview

The current invention in various embodiments enables a user to access information associated with a distant spatial location (or range of locations) by pointing a handheld computing device at that distant location (or range of locations). Various embodiments employ a portable computing device interfaced with a positioning system such as the Navstar Global Positioning System (GPS) in combination with a distributed network, such as the Internet, to provide real-time location specific information to a user. Such embodiments include a wireless transceiver for communicating to the distributed network. The GPS sensor generates a coordinate entry that relates to the then current location of the portable computing device. A unique location identifying method and apparatus is then used to identify a location that is some distance away from the then current location of the portable computing device as identified by the user of said portable computing device, said location identifying method allowing said user of said portable computing device to target a specific distant location or a range of specific distant locations that is a particular distance and orientation away from said then current location of the portable computing device. Said specific distant location or said range of specific distant locations is then transmitted as data to the distributed network, either directly or as a coded representation, for retrieval of corresponding location specific information. The location specific information may reside on a web page or may be stored as other forms of accessible data upon a networked server. Location coordinates may be incorporated into the web page address or may be linked to the web page as a relational association, associating that web information with a particular location that is the same as said specific distant location, falls within a range identified by said range of specific distant locations, or is within a certain proximity of said specific distant location or range of specific distant locations. Additional information may be associated with the web page such as priority information, category information, and/or weighting information. Optionally contingent upon said priority information, category information, and/or other conditional information, the web page and associated information may then be displayed.

The embodiments operate in three primary computational steps. The first step is the reading of position and orientation sensors local to a portable computing device, said position and orientation sensors including for example a GPS sensor and other orientation sensors such as an accelerometer and/or magnetometer to be described in more detail later. The reading of said sensors provides a positional coordinate and orientation direction for said portable computing device as positioned by the user. In the preferred embodiment the portable computing device is a handheld unit that can be freely aimed by the user at a target remote location in space. A variety of aiming tools and methods can be employed such as a laser pointer or a displayed image from a digital camera with overlaid crosshairs as to be described in more detail later. When the portable computing device is aimed at the target remote location in space (which can correspond with a remote target object), the user presses a button, performs a gesture, utters a word or phrase, or otherwise indicates to the system that the device is aimed at the remote target. Based upon said button press or other indication by the user that the device is aimed, the software running upon the portable computing device reads said position and orientation sensors to determine current positional coordinates and current orientation vector for said portable computing device.

The second step is the determination of distant target coordinates for a specific distant location or a range of specific distant locations that the user is targeting by aiming the portable computing device using the targeting tools and methods enabled (to be described later). For a specific distant location, the distant target coordinates are computed as the current positional coordinates with an offset added, said offset being a vector of length TARGET_DISTANCE and a direction pointing along the direction of the current orientation vector. For a range of specific distant locations, the distant target coordinates will include multiple values that define a range. For example, a MIN_TARGET may be computed that is equal to the current positional coordinates with a minimum range offset added, said minimum range offset being a vector of length (TARGET_DISTANCE−RANGE/2) and direction pointing along the direction of the current orientation vector. Similarly a MAX_TARGET may be computed that is equal to the current positional coordinates with a maximum range offset added, said maximum range offset being a vector of length (TARGET_DISTANCE+RANGE/2) and direction pointing along the direction of the current orientation vector. Note—the range can also include an angular range around the current orientation vector, computing target coordinates at maximum and minimum edges of said angular range as well as at maximum and minimum edges of said distance range. In this way a geographical space is outlined by a set of distant target coordinates that define the range of acceptable values. In the preferred embodiment the distant target coordinates are computed as latitude and longitude coordinates. In some embodiments the distant target coordinates also include range parameters and/or proximity parameters. Once the distant target coordinates are computed to define a specific distant location or range of specific distant locations.

The third step is to cross-reference the distant target coordinates with stored Internet information that is cataloged with respect to location information. In the preferred embodiments this information is cataloged based upon geographic coordinates (e.g., specific latitude and longitude coordinates) and so the step of cross referencing involves determining which web sites (or other Internet information) are associated with specific geographic coordinates that fall within a particular proximity of the distant target coordinates and/or fall within the defined range represented by the distant target coordinates.

The embodiments, which may be more generally referred to as “targeting-location-information-systems,” preferably comprises a portable computer or similar processor driven portable device such as personal digital assistant (PDA), portable media player, portable digital telephone, or processor enabled wristwatch. Said portable computer or other processor driven portable device includes targeting apparatus such that it can be aimed at a distant target by the user, said user interacting with a user interface upon said device to indicate when said distant target is aimed at. The portable computer or other processor driven portable device also includes ranging apparatus and/or methods such that when it is aimed at a distant target by the user, the distance to that target can be determined, estimated and bounded. The portable computer or other processor driven portable device also includes a wireless connection to a computational network such as the Internet and is connected to a local geographic sensing system including for example a GPS sensor and preferably other sensors such as an accelerometer and/or magnetometer. When said portable computer or other processor driven portable device is aimed at a distant target, signals from said sensors are used to determine current positional coordinates and a current orientation vector for said portable device. Said targeting apparatus is used to support the aiming process. Said ranging apparatus is used to derive and/or estimate and/or bound a distance to said distant target and/or a range of distances to said distant target and/or a range of aiming angles to said distant target. Said targeting and ranging apparatus may include automatic apparatus as well as user controlled apparatus, individually or combined. For example said targeting and ranging apparatus may include ultrasonic ranging, optical scopes, sensed optical focusing mechanisms, digital cameras, laser pointing, laser range-finding, and triangulation hardware and software. Regardless of the targeting and ranging apparatus used, said distance and/or range of distances and/or range of aiming angles are used as an offset that is added to said current positional coordinates in the direction of said current orientation vector to compute distant target coordinates. These distant target coordinates are transmitted to a server on the distributed network. The target coordinates may be combined with a URL to make a unique URL that references a web page on a predetermined server for a particular web page that describes that location. The target coordinates may also, for example, link to an existing web page on the distributed network associated with those coordinates. The web page and relationally associated information, such as historical information, local areas of interest, tree information, hill information, lake information, shopping centers and the like, are transmitted to the portable computing device and displayed.

For cases wherein multiple sets of information are associated with the current distant target coordinates, a prioritization method is employed that orders how the information is displayed to the user upon the portable device based upon one or more criteria. The criteria may include information about how near of a spatial match the web information is to the distant target coordinates. Web information that is nearest to a specific set of distant target coordinates or most centrally located within a range of distant target coordinates may be given higher priority. Also, content related criteria are used in addition to, or instead of, spatial location related criteria to prioritize, order, and/or filter the information that is displayed to the user. Said content related criteria may include for example a Targeting Context Type that indicates the general context within which the user is performing the location related information search. The Targeting Context can be defined, for example, as one or more general search contexts such as—Consumer, Educational, Historical, or Natural. The content related criteria may also include a Targeting Object Type that indicates the type of object the user desires information about when performing the location related information search. Said Targeting Object Type can be defined, for example, as one or more object types such as Trees, Plants, Landforms, Bodies of Water, or Manmade Structures, Historical Landmarks. The content related criteria may also include a prioritization rating that gives priority to certain web links based upon their popularity, their importance, or a paid priority fee.

As an example, a user might target a tree that is on a hill and right in front of a historic barn. In this example all three of the tree and the hill and the barn have information stored in the Internet about them linked to the same or similar geographic coordinates. As part of the targeting process, the user aims his portable computing device at the tree on the hill that is in front of the barn and indicates through the user interface that he or she is looking for information about a target of the Targeting Object Type equal to Foliage. Based upon this Targeting Object Type entered by the user the information is accessed and displayed for the tree, but not for the hill or the barn. Had there been multiple objects of type foliage within the range specified by the user, each of said multiple objects of foliage having location specific information linked to it with similar location addresses, information about those multiple objects of foliage may all be presented to the user, ordered based upon available prioritization information and/or ordered based on proximity to the user. For example if a tree that is particularly popular is located next to a common shrub, both with Internet information linked to the same or similar location, priority information may also be linked to those objects, in this case assigning higher priority to the tree than the shrub. The portable computing device, upon accessing the location specific information, said information including factual information about the foliage and priority information about the objects, displays the factual information ordered based upon the priority information—displaying the factual information about the tree first on a displayed list and factual information about the shrub second. Alternatively, the portable computing device may prioritize alone, or in combination with other information, based upon which object is closer to the user and/or which object is closer to said distant target coordinates or said range of distant target coordinates.

Important to the present embodiments is a targeting and ranging methodology in which a user accesses information that is linked to a specific remote location by aiming a portable computing device at a remote location, the information being accessed based upon one or more target coordinates representing the specific remote location, the target coordinates being generated by determining the current spatial location for the portable computing device and adding to it a vector offset, the vector offset having a direction based upon the orientation of said portable computing device when said portable computing device is aimed at said remote location. Said vector offset also having a distance magnitude based upon one or more ranging methods and/or technologies. In some embodiments the ranging methods and technologies are user controlled: for example by an electrical knob, slider, roller, lever, switch, button, graphical slider; by manual control; via a manual motion or gesture; or via a voice command. The specific or approximate distance can be a single distance or a range of distances. In other embodiments the ranging methods and technologies are automatically controlled, including for example an ultrasonic ranging sensor that automatically detects the line-of-sight distance to a targeted remote location, said distance being derived as either a single distance or a range of distances. In other embodiments said ranging methods and/or technologies include a laser range finder that automatically detects the line-of-sight distance to an object at said specific remote location, said distance being derived as either a single distance or a range of distances. In other embodiments said targeting and ranging methods and/or technologies includes an optical viewing lens aimed at the specific remote location, said optical lens optionally including crosshairs overlaid upon said users view of said specific remote location. In other embodiments said targeting and ranging methods and/or technologies includes a digital video camera that is aimed by said user at said specific remote location, an image from said video camera being displayed to said user upon a display on said portable computing device such that said user can see what is being aimed at and thereby target said specific remote location. In some embodiments said image displayed upon said portable computing device includes an overlaid cross-hairs or other graphical indicator that demarks the particular targeting location (or range of targeting locations) of said portable computing device as aimed by the user at a desired specific remote location. In some embodiments said ranging methods and/or technologies include a pair of cameras that capture a pair of images, the differences in said pair of images being used to derive a distance to an object at said specific remote location, said distance being derived as either a single distance or a range of distances. In some embodiments said targeting methods and/or technology include a laser pointer that can be aimed by said user at said specific remote location.

The embodiments include a portable computing device capable of interfacing with a remote network through a wireless connection and access location specific information from that network based upon what that portable computing device is being aimed at as determined in part from the location and/or orientation of the handheld electronic appliance at the moment said device is successfully aimed. To determine the location of said portable computing device when it is aimed at a specific remote location, said portable computing device includes GPS sensors. In preferred embodiments the portable computing device may include additional specialized sensors for orientation sensing such as accelerometer sensors, tilt sensors, magnetometer sensors. In preferred embodiments, the portable computing device includes a radio frequency (RF) transceiver for accessing said remote network such as the Internet. It should be noted that other bi-directional communication links can be used other than or in addition to RF. In a preferred embodiment a Bluetooth communication link is used to allow bidirectional communication to and from the portable computing device and said remote network.

The portable computing device includes a casing having a physical shape (in preferred embodiments) with a defined pointing end, a microcontroller, a wireless communication link such as the aforementioned RF transceiver, and position and orientation sensors which are connected to the microcontroller, and a power supply (e.g., batteries) for powering these electronic components. The portable computing device may also include other electronic components such as a user activated switches or buttons or levers or knobs or touch screens or microphones or speakers or LCD displays or lights or graphical displays. These components, which are also connected to the microcontroller, are employed for the purpose providing information display to users and/or for allowing the user to provide input to the system. These input and output components are collectively referred to as the User Interface (UI) of the portable computing device.

### DESCRIPTION OF DRAWINGS

As discussed above, the embodiments employ a portable computing device with position location system, interfaced with a distributed network system, and a communications interface to the distributed network system.

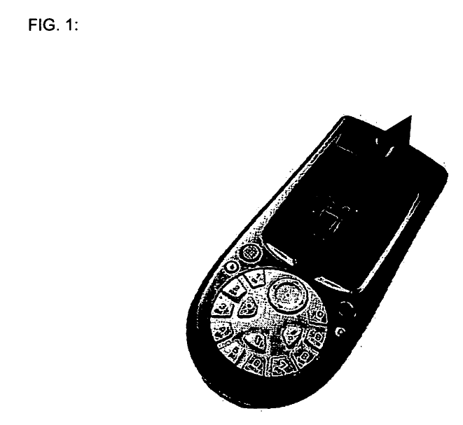

FIG. 1 illustrates a hand held embodiment of the present embodiment.

Referring to FIG. 1, a portable computing device configured with appropriate hardware and software to support the embodiments disclosed herein. Said portable computing device includes a computer processor, an information display, a user interface, and a wireless communication link to an distributed information network such as the Internet. The portable computing device also includes a differential GPS transceiver for sensing the geographic location of the portable computing device with a high degree of accuracy. The portable computing device also includes one or more orientation sensors such as a magnetometer for sensing geometric orientation with respect to geographic north and an accelerometer for sensing pitch angle of the device with respect to the gravitational horizontal when aimed at a remote location. Also the portable computing device is shaped such that it can be conveniently pointed at a remote location by a user. Also the portable computing device includes or more targeting and ranging methods and/or technologies for targeting a distant location aimed at by the user. For example the portable computing device may include an optical lens, a laser pointer, an ultrasonic sensor, a laser range finder, a digital camera, and/or a pair of stereo digital cameras. The portable computing device also includes a user interface component such as a button, knob, switch, lever, or trigger that the user manipulates so as to indicate that the portable computing device is then currently aimed at a desired remote location.

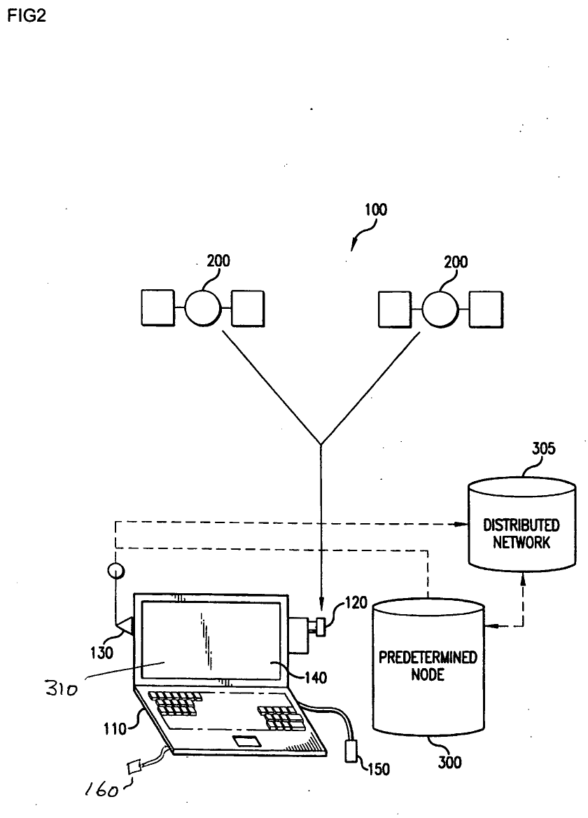

FIG. 2 illustrates a systems diagram of important subsystems in accordance with many embodiments of the present invention.

Referring to FIG. 2 one embodiment of a targeting-location-information-system 100. As seen in FIG. 2, the targeting-location-information-system 100 includes a portable computing device 110, a GPS receiver 120 connected to the portable computing device 110, a targeting device 115, GPS transmitters 200, a wireless transceiver 130 is connected to the distributed information network 305.

The portable computing device 110 can consist personal digital assistant (PDA) or cell phone or portable gaming system or portable media player configured with the appropriate hardware and software to support the current embodiments. As shown in the figure, the portable computing device 110 includes a GPS receiver 120 and a radio transmitter/receiver, e.g., transceiver 130, and one or more orientation sensors such as a magnetometer 140 and an accelerometer 150. The GPS receiver 120 receives signals from three or more GPS transmitters 200 and converts the signals to a specific latitude and longitude (and in some cases altitude) coordinate as described above. The GPS receiver 120 provides the coordinate to the software running upon portable computing device 110. The orientation sensors provide orientation data to software running upon the portable computing device 110, said orientation data indicating the direction at which the portable computing device 110 is pointing when aimed at a remote location by the user. Additional ranging technology may be included, the ranging technology used by the user to determine, estimate, and/or indicate the line-of-sight distance or a range of distances to the desired target location.

Distributed information networks 305, such as the Internet and other private and commercial distributed networks are a source of useful information. This information varies from advertisements to educational information to business data to encyclopedic information. This information is typically resident on a particular web page having a unique URL or address that is provided on the World Wide Web, for example. For a user to obtain this information, the user either enters into the computer a unique URL for retrieving the web page or certain keywords in order to search for the web page using well-known search engines.

GPS technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed with reference to the present embodiments. However, other positioning systems are also contemplated for use with variations of the present embodiments. In order for GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver 120 then compares its time to the synchronized times and the location of the GPS satellites. This comparison is then used in determining an accurate coordinate entry.

In order to gain orientation information, one or more sensors may be included within or affixed to the portable computing device 110. Some sensors can provide tilt information with respect to the gravitational up-down direction. Other sensors can provide orientation information with respect to magnetic north. For example an accelerometer may be included to provide tilt orientation information about the portable computing device 110 in one or two axes. In some embodiment a single axis accelerometer is used that senses the pitch angle (tilt away from horizontal) that the portable computing device 110 is pointing. In other embodiments a 2-axis accelerometer can be used that senses the pitch angle (tilt away from horizontal) that the portable computing device is pointing as well as the roll angle (left-right tilt) that the portable computing device is pointing. A suitable accelerometer is model number ADXL202 manufactured by Analog Devices, Inc. of Norwood Mass. To sense the orientation of the portable computing device with respect to magnetic north, a magnetometer is included. In one embodiment a 3-axis magnetometer model number HMC1023 manufactured by Honeywell SSEC of Plymouth, Minn. is included. This sensor produces x, y and z axis signals. In addition, some embodiments may include a gyroscope such as a 1-axis piezoelectric gyroscope model number ENC-03 manufactured by Murata Manufacturing Co., Ltd. of Kyoto, Japan to further sense changes in orientation of the portable computing device. All of said orientation sensor may all be housed within the casing of the portable computing device and be connected electronically to the microprocessor of the portable computing device such that the microprocessor can access sensor readings and perform computations based upon and/or contingent upon said sensor readings.

The user of said portable computing device 110 aims the device at a specific remote location using one or more targeting methods and technologies described herein. In the embodiment shown, targeting device 115 is a device that consists of a digital camera or integrated laser pointer. Also optionally included are automatic ranging hardware such as an ultrasonic sensor or laser range finder.

The operation of the embodiments referenced in FIG. 2 is described as follows:

The user aims the targeting device 115 at a desired remote location and presses a button upon said portable computing device 110 to indicate that the device is currently aimed. The software running upon said portable computing device 110 then computes a coordinate or set of coordinates for the desired remote location. The coordinate is computed in software by adding an offset to the current GPS location (as detected by said GPS sensor) of the portable computing device 110. The offset is a vector that includes a distance magnitude and a direction. The direction is derived using the magnetometer 160 which gives an orientation vector with respect to magnetic north. The direction may also include a pitch angle with respect to the gravitational horizontal. This pitch angle can be derived from the sensor data collected from an on board accelerometer 150. The distance magnitude is derived in one of a number of ways. It can be estimated by the user controlling a user interface such as a ranging knob or slider. It can be computed using a ranging sensor such as an ultrasonic transducer or a laser range finder. The distance magnitude can be a single value or a range of acceptable values as specified by the user. Based upon the offset vector (distance magnitude and orientation direction), target GPS coordinates are computed for the targeted remote location by adding said offset to the GPS location of the portable computing device 110. The Target GPS Coordinates can be a single set of coordinates, a range of coordinates, or a single set of coordinates with some additional parameters that define the range of acceptable coordinate values. The target GPS coordinates are then sent by transceiver 130, preferably via a radio network, to a predetermined node 300 or other node on a distributed network 305. Alternatively, the target GPS coordinates are transmitted to the distributed network 305.

Information associated with the target GPS coordinates is then transmitted to the computer 110 via the transceiver 130 (i.e., by either a radio network or other wireless or wire communication link) and displayed on the display 140. In the event that numerous pieces of information are associated with the target GPS coordinates, the information that is displayed may be dependent upon additional prioritization information or how the information is displayed (i.e. the order said numerous pieces on information are displayed) may be dependent upon additional prioritization information. In addition, the user may select a TARGETING CONTEXT and/or TARGETING OBJECT TYPE when pointing at a location and requesting information. When a TARGETING CONTEXT and/or TARGETING OBJECT TYPE is selected by the user, only information of that TARGETING CONTEXT and/or TARGETING OBJECT TYPE may be displayed to the user by the display of said portable computing device. For example, if the user is pointing at a location that contains numerous pieces of information and selects a TARGETING CONTEXT of “Educational”, only information of CONTEXT TYPE “Educational” will be displayed. Similarly, if the user is pointing at a location that contains numerous pieces of information and selects a TARGETING OBJECT TYPE of “foliage”, only information of OBJECT TYPE “foliage” will be displayed. In this way the user can point at a remote location that may be crowded with diverse information and only review that information of a desired CONTEXT TYPE and/or OBJECT TYPE.

Information about various locations is organized and stored on the distributed network and is preferably organized as “web pages.” A plurality of different web pages or other web-based information segments may be associated with the same or similar locations. Said web pages may also contain data that associates the information with one or more OBJECT TYPES and/or one or more CONTEXT TYPES. An OBJECT TYPE associates information with a particular type of object that resides at the particular location. Example OBJECT TYPES include trees, plants, landforms, bodies of water, residences, businesses, parks, outcroppings of rock, natural landmarks, manmade landmarks, sports fields, streets, bridges, tunnels, stores, restaurants. A CONTEXT TYPE associates information with a particular context of inquiry that the user may be engaged in. Example CONTEXT TYPES include consumer, educational, historical, natural. Web pages or pointers to the web pages or other web-based information segments are preferably stored on the predetermined node 300 of the distributed network 305. However, the web pages may also be stored at various other nodes on the distributed network 305 and may be associated with one or more location coordinate corresponding to physical locations. The web pages may have, for example, an already existing URL, e.g., a proprietary pre-existing URL. Alternatively, coordinate information may be incorporated into an existing URL to form a unique URL. Further, the coordinate may also be the entire URL of the web pages. A client, either local or remote, may access the web pages preferably via a server on the predetermined node 300 of the distributed network 305.

In preferred embodiments, the targeting-location-information-system 100 transmits, via the transceiver 130, the target GPS coordinates directly to the predetermined node 300 of the distributed network 305 having the web pages associated with those coordinates residing thereon. In this case, the web pages and the associated coordinates are stored on the same node of the distributed network 305. Alternatively, the web pages and the associated coordinates may be stored on separate nodes of the distributed network 305.

In embodiments when the location coordinates are provided on a separate node distinct from the node or nodes storing the corresponding web pages, the targeting-location-information-system 100 provides a reference page on the predetermined node 300 of the distributed network 305. The reference page provides a “hyperlink” to a web page or pages located on separate nodes. In the case when the web page is located on a separate node, a directory list of names of all web pages associated with particular coordinates may be stored on the predetermined node 300. The directory page may then access the directory list in order to determine whether the web page associated with a particular coordinate resides on another node of the distributed network 305. In some embodiments the computer 110 transmits the hyperlink string and receives the web pages via the transceiver 130. The corresponding web pages residing on a separate node of the distributed network 305 may also be directly accessed from the predetermined node 300 and downloaded to the computer 110 via the radio transceiver 130 without the use of the hyperlinks. In some embodiments this may be provided by a common gateway interface script (CGI). The corresponding web pages provide the user with specific information associated with the coordinates (or range of coordinates) representing that location (or range of locations).

A directory page associated with several coordinate or ranges of coordinates may be retrieved from the distributed network 305, as discussed above. As previously discussed, the directory page may list several web pages that are associated with particular coordinates (or ranges of coordinates) and provide links to the associated web pages. The retrieved web pages may provide location specific information related to those particular locations (or objects at those particular locations) as designated by said coordinates or ranges of coordinates.

The GPS receiver 120 of the targeting-location-information-system 100 is can be, for example, a PCMCIA Pathfinder Card (with associated hardware and/or software) manufactured by Trimble Navigation Ltd., Sunnyvale, Calif., for receiving information from the GPS transmitters 200. The GPS receiver 120 may be integrated directly into the portable computing device and not be an extractable card. The radio transceiver 130 of the targeting-location-information-system 100 can be a cellular modem radio or other wireless link. The radio transceiver 130, for example, may work with a Ricochet Wireless Network system manufactured by Metricom, Inc. The radio transceiver 130 may also comprise other systems, such as, for example, a cellular digital packet data (CDPD) type radio transceiver. The radio transceiver 130 may also, for example, be a Bluetooth wireless communication connection.

As described above, the coordinates may be referenced to a URL residing on the predetermined node 300. The web page 310 may have a unique pre-existing URL, such as, for example, http://www.remotelocation.com, or may use the coordinate as part of the URL, such as, http://www.remotelocation.com/coordinates/<lat>/<long>/<alt> where <lat> is the latitude and <long> is the longitude and <alt> is the altitude. In some embodiments the altitude variable is not used. The coordinate entry may alternately be referenced to the directory page on the predetermined node 300 which links to an existing web page on a separate node of the distributed network 305.

Because web based information can be stored with associated coordinates of varying levels of resolution, an important aspect of the present embodiments is the ability to access web information with associated coordinates that are within certain proximity of said Target GPS coordinates and/or have associated coordinates that fall within a range defined by said Target GPS Coordinates. In this way an exact match is not needed between said Target GPS Coordinates and the coordinates associated with a given piece of information to access that information by the remote targeting methods described herein. Also in this way small errors in remote targeting and/or in GPS sensing can be accommodated for. In this way the user can point in the direction of a desired location and receive information about that location even if the targeting accuracy is not perfect so long as the coordinates of that location are within a defined proximity of said Target GPS Coordinates and/or fall within a range of coordinates defined by said Target GPS Coordinates. In the preferred embodiment the user can set the defined proximity of acceptable targets by accessing a menu driven interface upon said portable computing device. In a simple embodiment, for example, can define the proximity as 10 feet, thereby accessing all web links with coordinates that fall within 10 feet of the Target GPS Coordinates. A problem with this simple method is that when the portable computing device is aimed at something near, the 10 foot proximity may be too large an area, and when the portable computing device is aimed at something far, the 10 foot proximity may be too small of an area. To solve this problem a more advanced method has been developed wherein the acceptable proximity is a percentage of the measured or estimated distance to the remote target. The percentage can be set by the user by accessing a menu driven interface upon said portable computing device. For example the user can define the proximity as 20% of the distance to the remote target. In this way when the user is pointing at a remote location that is, for example, 10 feet away, any information with associated coordinates that falls within a 2 foot proximity of the Target GPS Coordinates would be accessed and displayed to the user (except when excluded by priority, target context type, or target object type as described previously). Also, when the user is pointing at a remote location that is, for example, 80 feet away, any information with associated coordinates that fall within a 16 foot proximity of the Target GPS Coordinates is accessed and displayed to the user (except when excluded by priority, context type, or target object type as described previously). In an even more advanced embodiment instead of a simple percentage, which is a linear relationship between proximity size and distance to the target location, non-linear relationships can be used.

In one embodiment of the control routine implemented by the portable computing device 110. Control initiation can occur continuously as every new position coordinate and orientation data is sensed, or preferably based upon user input indicating that the portable computing device 110 is properly aimed at a remote target. Furthermore, the user can toggle between a continuously updating mode, where every newly computed remote location coordinate is transmitted to the distributed network 305 while the user is actively in the process of aiming the portable computing device, and a “one-shot” mode where the user sends the remote location coordinate data at discrete moments when he or she believes that the portable computing device 110 is properly aimed. Said one-shot mode is particularly useful when certain targeting technologies are used in the present embodiments (as described later in this document) such as a laser pointer, optical lens, and/or digital camera aiming system. When the user targets a remote location using one or more of said targeting technologies, the user presses a button on the portable computing device or otherwise engages the user interface of the portable computing device to send the currently computed remote location coordinate to the distributed network and access information about that remote location.

The remote location coordinate is computed in a number of steps, the order of which can vary from embodiment to embodiment. In one embodiment the first step is to sense the location of the portable computing device 110 by reading the GPS sensor. The second step is to sense the orientation of the portable computing device 110 by reading the orientation sensors such as the magnetometer and/or accelerometer. The third step is to determine the distance or range of distances to the remote location being aimed at. This determination can be computed based upon ranging sensors such as a laser range finder or ultrasonic sensor. This determination can be computed based upon an optical focusing mechanism in which the user focuses an optical lens upon the desired remote location and a sensor in the focusing mechanism determines the relative placement of lenses and thereby estimates the distance or range of distances to the remote location being aimed at. This determination can be computed based upon a triangulation mechanism in which the user aims multiple lenses, cameras, lasers, or other aiming devices at a remote location and the determination of distance or range of distances to the remote location being aimed at is determined based upon the relative angle of said multiple aiming devices. This determination can also be entered by the user, said user estimating the distance or range of distances by engaging the user interface of the portable computing device. In one such embodiment the user has a RANGE KNOB, RANGE ROLLER, or RANGE SLIDER that can be manipulated by a finger to indicate the estimated range from near to far based upon its absolute position or its relative position change. Said range knob, for example, could be a continual roller that is sensed by an optical encoder, data from said optical encoder being sent to said portable computing device. In another embodiment the user controls a graphical slider or other graphical interface displayed upon the screen of said portable computing device to indicate the estimated distance or range of distances to the desired target location. For example the user can control a graphical interface to indicate the near distance edge and far distance edge of the range within which the desired target it estimated to be. As another example the user can control a graphical interface to indicate an estimated distance to the remote location being targeted as well as a proximity distance to that target that is acceptable for information retrieval. In the fourth step the portable computing device computes target coordinates (or a range of target coordinates) for the desired remote location. Said target coordinates are computed by adding an OFFSET VECTOR to the GPS location coordinates sensed in the first step, said GPS location coordinates indicating the then current location of the portable computing device. Said OFFSET VECTOR has a direction computed based upon the orientation data sensed in the second step. Said OFFSET VECTOR has a distance (or a range of distances) based upon the distance values determined in the third step. It should be noted that in preferred embodiments these four steps are performed once the user has aimed the portable computing device at a desired remote location and indicates that the aim is set by engaging a user interface (such as a button or other control) upon said portable computing device 110.

Once the target coordinates are computed in the fourth step, these coordinates are used by said portable computing device 110 to access location related information from the distributed network 305. In a first set of embodiments all information linked to coordinates that correspond with said target coordinates are accessed and displayed to the user. In a second set of embodiments all information that is linked to coordinates that fall within a certain proximity of said target coordinates are accessed and displayed to the user. In a third set of embodiments all information that is linked to coordinates that fall within a particular range or area defined by said target coordinates are accessed and displayed to the user. In some embodiments the user may select through the user interface which of these first, second, and third set of embodiments is implemented upon his or her portable computing system. In a forth set of embodiments, the information received by said first, second, and/or third set of embodiments may be limited only to information that matches some search criteria and/or is above some defined priority level. In this way the user can limit the information that is displayed to only information that is relevant to the user's then current information search and/or only to information that is of high enough priority level. As described herein, the search criteria could be a TARGET CONTEXT TYPE and/or a TARGET OBJECT TYPE that defines the context within which the user is searching for information and/or the type of object about which the user is searching for information respectively.

An important aspect of the present embodiments is the ability of a user of a portable computing device 110 to target a remote location that they are looking at in the distance and gain information about that location and/or about objects that reside at that location. As described herein, the hardware employed by the current embodiments incorporates position sensor technology such as GPS that tracks the geographic location of said portable computing device 110 as carried about by said user. As also herein the hardware employed by the current embodiments incorporates orientation sensor technologies such magnetometers and accelerometers that track the orientation of said portable computing device, said orientation indicating the direction that said portable computing device (or a portion thereof) is pointing as held by the user. The magnetometer 160 and accelerometers 150 can determine the spatial orientation with respect to magnetic north as well as the spatial orientation with respect to the downward direction due to gravity. In this way the software running upon said portable computing device 110 can determine not only where the user is in the world (based upon position data collected by said GPS sensors) at particular points in time, but also what direction the user is pointing at (based upon orientation sensor data) as the user manipulates the portable computing device (or a portion thereof) and aims it at a desired remote target. This action by the user of aiming said portable computing device 110 (or a portion thereof) at a particular remote target is referred to herein as targeting and involves the user pressing a button or otherwise manipulating a user interface to indicate that the portable computing device 110 is then aimed at a remote target about which information should be accessed off the Internet. As described herein, the user can through said user interface define the Target Context Type and or Target Object Type as a way to specify the context within which the user is searching for information and/or the type of object about which the user is searching for information respectively.

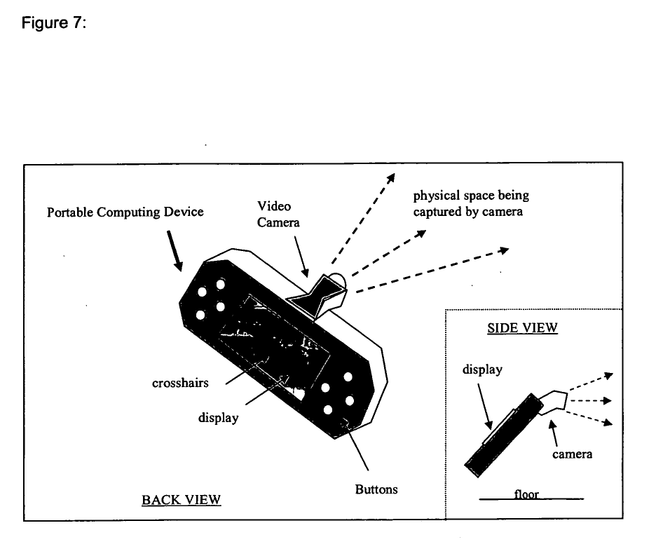

All this said, there still remains a need for additional inventive methods and apparatus to enable a user to accurately aim the portable computing device 110 at a particular remote location and press said button (or otherwise manipulate said user interface) to indicate that the portable computing device 110 is then aimed at a particular remote target about which information should be accessed. This is because it is difficult for a user to know with significant accuracy how well he or she is aiming said portable computing device (or a portion thereof) at a particular remote location that is some distance away from where the user is standing. In addition there may be many different objects and/or many different locations in close proximity that a user might target and so increased accuracy will greatly facilitate a user's ability to gain desired information by targeting remote locations. To satisfy this need a number of inventive methods and apparatus have been developed that facilitate targeting. These methods are described with respect to a preferred embodiment—a portable computing device that is a handheld unit that can be aimed at a remote location by the user. One example of such a handheld device is shown in FIG. 1 another example is shown in FIG. 7.

This first method enhances a user's ability to target a remote location by including a laser pointer within the casing of said portable computing device such that when the portable computing device is held in the hand of the user and aimed at a remote location, said laser pointer shines in the aiming direction. A button or other user manipulatable interface is included upon the portable computing device such that the user can selectively activate said laser pointer. When the laser pointer is on the user can see an illuminated dot indicating where the portable computing device 110 is then currently aimed. This illuminated dot serves as a highly valuable reference for said user such that the user can move the portable computing device around in his hand, changing its orientation in space, until said illuminated dot is shining upon the desired target location. The user can then press another button (or otherwise interact with the user interface of the portable computer system) to indicate that the desired aiming has been achieved. The portable computing device 110 then reads the position sensors and orientation sensors (and optionally the ranging sensors and/or ranging user input controls) to determine the remote location or the range of remote locations that is being targeted by the user at that time.

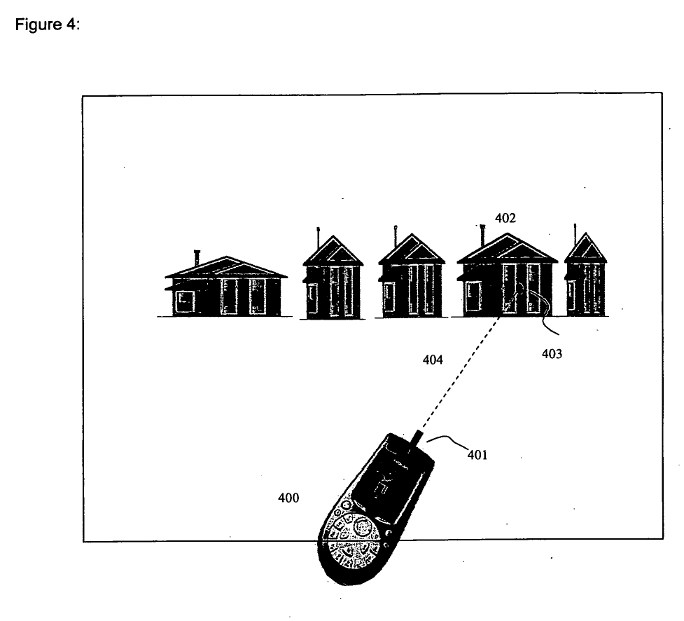

As shown in FIG. 4, a handheld portable computing device 400 is equipped with a GPS sensor for tracking its position. Also included is one or more orientation sensors for tracking the direction the handheld portable computing device is aimed by the user who is holding it. Also included and shown in the figure as element 401 is an integrated laser pointer for projecting a red dot 403 upon objects that fall within the line-of-sight aiming direction of the portable computing device. The laser beam is represented by dotted line 404 and projects as a straight line along the direction of aiming. In this figure the user aims the portable computing device at one of five houses that are visible to the user, using the laser pointer to aid in the aiming process. By watching the location of the red dot 403 the user knows where he is aiming the portable computing device as he or she changes the orientation. Once the portable computing device is aimed at the desired target 402 which is the forth house from the left in the figure, the user presses a button (or otherwise engages the user interface on the portable computing device) to access information from the Internet about the location being pointed at as referenced by the remote location coordinate. The information accessed is displayed to the user on the screen of said portable computing device and/or optionally played as audible information over a speaker or headphone on the portable computing device. If the house is a residence, the information includes for example the names of the people who live in the house. If there is a business within the house the information includes, for example, the name of the business and a description of the products and/or services of the business. If the house is a historical landmark, the information includes, for example, historical information about the house.

It should be noted that the portable computing device 110 includes, in preferred embodiments, a user interface button or other manipulatable interface for turning on the laser pointer at desired times. The user will use this button to turn on the laser pointer only when he or she desires aid in aiming the portable computing device 110 at a desired target.

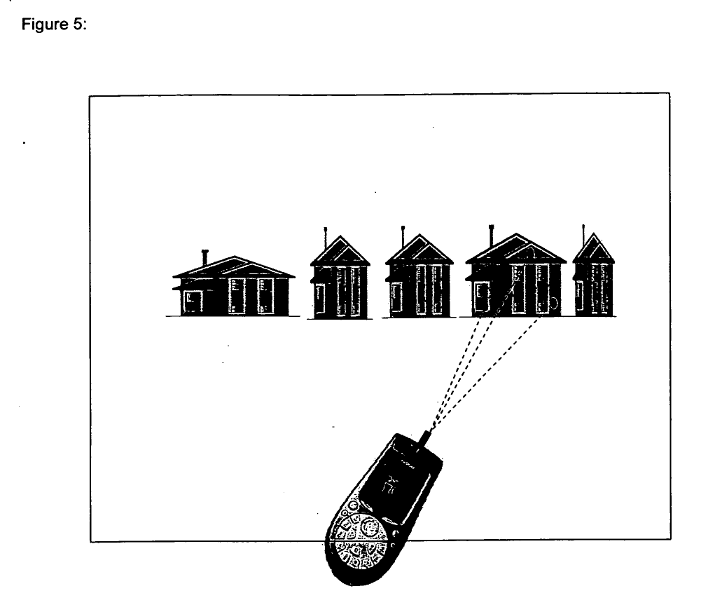

It should also be noted that in many cases the size of the target area is substantially larger than the size of the laser dot displayed by the targeting aid. In some embodiments the targeting aid can also depict the size of the targeting area by displaying multiple dots and/or other projected images. For example, three dots can be projected to outline a triangle that roughly estimates the size of the targeting area. FIG. 5 shows an example of such an embodiment. When using such an embodiment the user would center the desired target within the range defined by the multiple dots.

The second method enhances a user's ability to target a remote location by including a digital video camera within the casing of said portable computing device such that when the portable computing device is held in the hand of the user and aimed at a remote location, said camera captures an image in the in the aiming direction, said image being displayed upon the screen of said portable computing device, said image depicting that part of the real physical space which is being aimed at by the user. In some embodiments everything that is displayed upon the screen falls within the range of remote locations being aimed at within the real physical space. In other embodiments, a point on the image at the center of the screen (or near the center) is that location that is being aimed at in the real physical space. In such embodiments graphical crosshairs can be optionally overlaid upon the displayed image to indicate the point on the image that is being aimed at within the real physical space. In other embodiments a particular area of the image on the screen is the area of locations that is being aimed at in the real physical space. In such embodiments a graphical image depicting the selection area (such as a box or a circle or a shaded region) may be optionally overlaid upon the displayed image to indicate the area on the image that is being aimed at within the real physical space.

The size of said selection area can be optionally controlled by said user through the user interface on said portable computing device, by changing said size of said selection area said user can change the size of the range of distant location values for which information is requested. For example if the user sets the size of said area to be large, a large range of remote location coordinates are sent to the network as part of the information retrieval process. But if the user sets the size of the area to be small, a small range of remote location coordinates are sent to the network as part of the information retrieval process. Said another way, if the user sets the size of the selection area to be large the software retrieves location related information within a larger proximity of the targeted location than if the user sets the size of the selection area to be small.

A button or other user manipulatable interface is included upon the portable computing device such that the user can selectively activate said digital camera such that the image of the remote location being aimed at is displayed. This displayed image serves as a valuable reference for said user such that the user can move the portable computing device around in his hand, changing its orientation in space, until said image includes the desired target location. The user can then press another button or otherwise interact with the user interface of the portable computer system to indicate that the desired aiming has been achieved. The portable computing device then reads the position sensors and orientation sensors and optionally the ranging sensors and/or ranging user input controls to determine the remote location and/or the range of remote locations that is being targeted by the user at that time.

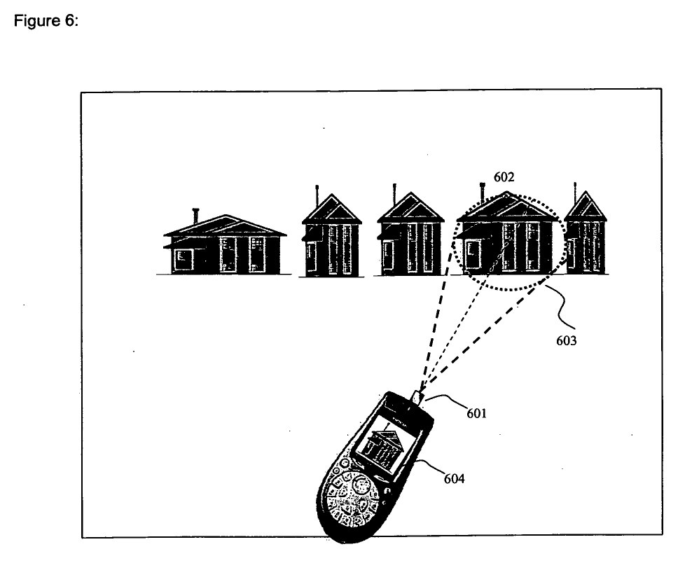

FIG. 6 shows a portable computing device equipped with a GPS sensor for tracking its position and one or more orientation sensors for tracking the direction it is aimed by a user. Also shown is an integrated digital video camera 601 for capturing a line-of-sight image in the direction that the portable computing device is aimed by the user. The dotted lines 603 in the figure indicate the field of view of the camera as determined by the optics and how the portable computing device is aimed by the user. The captured image 604 is displayed upon the screen of said portable computing device showing the user what is being aimed at and thereby assisting in the targeting process. Cross hairs and/or other graphics (not shown) may be overlaid upon the displayed image to assist the user in accurate targeting. In this figure the user aims the portable computing device at one of five houses that are visible to the user, using the displayed image captured by said camera to aid in the aiming process. By watching the displayed image the user knows where he is aiming the portable computing device as he or she changes the orientation. Once the portable computing device is aimed at the desired target 602 which is the forth house from the left in the figure, the user presses a button to access information from the Internet about the location being pointed at as referenced by the remote location coordinate. The information accessed is then displayed to the user on the screen of said portable computing device and/or optionally played as audible information over a speaker or headphone on the portable computing device. If the house is a residence, the information includes for example the names of the people who live in the house. If there is a business within the house the information includes, for example, the name of the business and a description of the products and/or services of the business. If the house is a historical landmark, the information includes, for example, historical information about the house.

An optical and/or digital zoom feature (not shown) can be employed within the digital camera embodiment described in the paragraphs above. Such an optical and/or digital zoom can allow the user to zoom-in or zoom-out with the camera and thereby change the field of view displayed upon the screen. By changing the displayed field of view by adjusting said optical and/or digital zoom, the user changes the range of distant location values for which information is requested. For example if the user zooms out, a large range of remote location coordinates are sent to the network as part of the information retrieval process. But if the user zooms-in, a small range of remote location coordinates are sent to the network as part of the information retrieval process. Said another way, if the user zooms-out, the software retrieves location related information within a larger proximity of the targeted location than if the user zooms-in.

A manual and/or automatic focus mechanism (not shown) can be employed within the digital camera embodiment described in the paragraphs above. Such a manual and/or automatic focus mechanism can be used along with the zoom function to determine and/or estimate range information to a remote target location. In one embodiment the user can manually twist a lens to bring an object into focus. A sensor mounted upon the lens adjustment mechanism, such as an optical encoder, detects the position of the lens or lenses within the focus mechanism. The portable computing device processor, by reading said sensor, can determine and/or estimate the distance or range of distances to the location that is then currently in focus. In this way a user's manual adjustment of an optical focusing mechanism can be used to provide ranging information to a desired distant target. In other embodiments an electromechanical focus mechanism is used such that a user can press buttons or levers or knobs to electrically zoom and focus the lens mechanism. Such an embodiment also includes a sensor mounted upon the electromechanical lens adjustment mechanism, such as an optical encoder, detects the position of the lens or lenses within the focus mechanism. The portable computing device processor, by reading said sensor, can determine and/or estimate the distance or range of distances to the location that is then currently in focus. In this way a user's manual adjustment of an optical focusing mechanism can be used to provide ranging information to a desired distant target. In many embodiments, such focusing mechanisms have a maximum focal length distance referred to generally as infinity. When the focus is set to infinity the user and/or computer processor must assume that the distance is greater than set maximum focus ranging distance.

FIG. 7 shows an example of a handheld portable computing device configured with a digital video camera for use in targeting remote locations. Shown is a portable computing device with a camera attached such that the user can view the display on the back of the portable computing device while aiming the camera forward into the real physical space within which the user is walking. As shown the camera points away from the user. Also shown is the unique angle at which the camera is affixed to the portable computing device such that the display can be tilted forward at a convenient angle and the camera is then level with respect to the ground. This allows said user to view the display conveniently while walking about the real physical space. By convenient it is meant that the user can hold the portable computing device at a comfortable height before him or her, tilted forward such that the display is clearly visible without the device significantly blocking the user's direct visual sight of the physical space. Some embodiments allow a user-adjustable angle such that the angle is automatically detected by a sensor in the connection between the camera and the portable computing device or such that the angle is automatically sensed by calibrating the camera image with respect to the ground level or other horizontal or vertical reference. In some embodiments a tilt sensor is used to sense the orientation of the camera with respect to the real physical space and updates software accordingly.

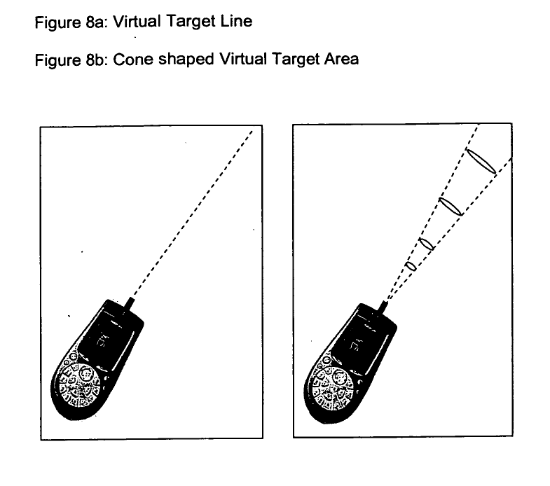

A third method allows the user to aim the portable computing device in a particular direction, an aiming vector is defined that will intersect an infinite number of target remote locations that fall along the line-of-sight of that aiming vector. For all practical purposes, the vector need not extend infinitely in aiming direction, but only along a reasonable maximum viewing distance of the user. This reasonable maximum viewing distance can be set by the user through the user interface on the portable computing device. The reasonable maximum viewing distance may vary depending upon the setting of the user. In an urban setting it may only be a few hundred feet. In a rural setting it may be a few thousand feet. Regardless of what it is set at, there are an infinite number of remote distance locations that fall along the target line defined by the vector starting from the portable computing device and extending along the direction the portable computing device is aimed by the user. In some embodiments a target area is used instead of a target line, said target area being defined as a range of orientations rather than a single orientation. For example the target area is defined in some embodiments as a cone with a swept 1 degree angle around the vector extending from the portable computing device outward towards the target location. FIG. 8a shows a conceptual drawing of a target line extending out from the portable computing device in the aiming direction. FIG. 8b shows a conceptual drawing of a cone shaped target area extending out from the portable computing device in the aiming direction.

With respect to FIGS. 8a and 8b, a virtual target line or virtual target area extends from the portable computing device in the direction it is aimed by the user. Said virtual target line or virtual target area will intersect a great many target location coordinates in the range between zero distance away from the portable computing device and a maximum distance defined as the reasonable maximum viewing distance. Only some of the intersected target location coordinates will have information stored on the network associated with them. For example, a user might be standing in a park and aiming their portable computing device into the distance—there might be 10 different coordinates that have information associated with them intersecting the virtual target line at the moment the user has aimed the device and requested information. Some of those 10 may be near and some of those 10 may be far. If a virtual target area is used in this example there would likely be more intersected coordinates that have information associated with them for the virtual target area covers a larger spatial area. For example there may be 22 different coordinates that have information associated with them intersecting the virtual target area at the moment the user has aimed the portable computing device and requested information. If the embodiment lacks ranging information, there is no way for the software running on the portable computing device to determine which of the 10 (or 22) different locations the user had intended to target. A number of the possible coordinates might be eliminated by matching TARGET CONTEXT TYPES and/or TARGET OBJECT TYPES as described previously in this document. That said there still could be a number of different targets with information associated with them that match the user's current TARGET CONTEXT TYPE and/or TARGET OBJECT TYPE. For example the user might have selected a TARGET OBJECT TYPE as “Natural Landmarks” and there may still be many that intersect the virtual target area. For example, of the 10 different coordinates that have information associated with them intersecting the virtual target line at the moment the user has aimed the device and requested information, 6 of them might be of OBJECT TYPE “Natural Landmarks” and so the portable computing system may still not know which of the multiple locations the user had intended to target.

To deal with situations wherein a plurality of different coordinates with information associated with them are identified as being within a certain proximity of and/or as intersecting a given target line or target area, a number of different methods have been developed.

In the first of these methods Information associated with said plurality of different coordinates are ordered from near to far, the information associated with the nearest coordinates being displayed first on a list and the information associated with the farthest coordinates being displayed last. The displayed listing can also include a distance measurement from the user so that the user knows how far each of said associated coordinates are from where he or she is standing. For example, three information segments were retrieved by a user in a park who was searching for TARGET OBJECT TYPES equal to trees. The information would be displayed about the three trees in order from nearest to farthest. The nearest tree information might be about a ¢California Oak”, the next nearest might be about a “Torrey Pine”, and the farthest might be about a “Spruce”. The information would be displayed to the user in a list from nearest to farthest, a distance measurement optionally being displayed along with each element of the list indicating how far that location is from the user. Assuming that this user can see the three trees and can perceive their relative distance, this method makes it easy for the user to associate the gathered information with the correct tree. The user now knows that the nearest tree he sees is a California Oak, the next tree is a Torrey Pine, and the farthest tree along his aiming direction is a White Spruce. Note—the user can optionally have the list displayed with nearest elements on the top of the screen and farthest elements on the bottom, or vice versa.

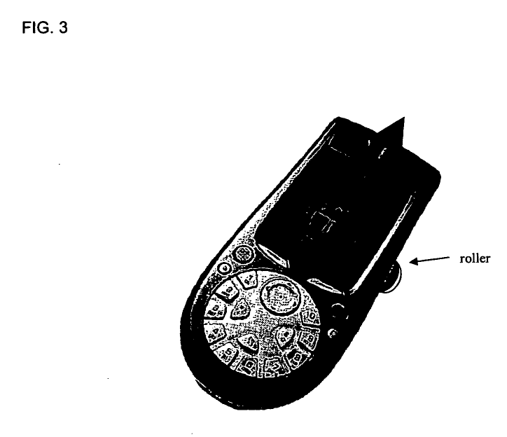

In another of these methods information associated with said plurality of different coordinates are ordered from near to far, the information associated with the nearest coordinates being displayed on the screen along with an optional numeric or graphical indication of its distance from the user. The user can then use a scrolling interface such as a finger operated mechanical roller like the one shown in FIG. 3 to indicate his or her desire to scroll through information from near to far, displaying each subsequent information piece associated with the next farther coordinate on the list as the user rolls the roller with his or her finger. Other user interfaces may also be used such as a knob, rocker switch, lever, or hat switch to indicate his or her desire to scroll through information from near to far, displaying each subsequent information piece associated with the next farther coordinate on the list. For example, three information segments were retrieved by a user in a park who was searching for TARGET OBJECT TYPES equal to trees. The information about the nearest tree is displayed first. The nearest tree information might be about a “California Oak”. The user can then engage the user interface such as the roller and roll it forward to scroll to the next nearest information piece. In this example the next nearest piece of information associated with an intersected coordinate might be about a “Torrey Pine”. The user can review this information and/or scroll back the previous information (by rolling the roller backwards) and/or scroll to the next nearest information piece (by rolling the roller forward) which in this example might be about be about a “White Spruce”. Each information segment is optionally displayed along with a numerical or graphical indication of how far its coordinate location is from the user. Assuming that this user can see the three trees and can perceive their relative distance, this method makes it easy for the user to scroll near and far through the information along the virtual target line or virtual target area and associate the gathered information with the correct trees that he or she sees before him. In this way the user can aim his portable computing device in a certain direction and then scroll from near to far using a knob, roller, graphical slider, or other user interface element, reviewing each information segment that is intersected along the target line or target area progressing from near to far.

Also the system can be configured to allow a user to scroll from far to near (rather than near to far) using the same method but simply starting with the farthest information segment displayed first. Also, the system can be configured to allow users to view information at a midpoint of the target or target area first and then optionally scroll near or far from that midpoint.

This invention has been described in detail with reference to preferred and alternate embodiments. It should be appreciated that the specific embodiments described above are merely illustrative of the principles underlying the inventive concept. It is therefore contemplated that various modifications of the disclosed embodiments will, without departing from the spirit and scope of the invention, be apparent to persons of ordinary skill in the art.

What is claimed is:

1. A system for retrieving information that is relationally associated with a distant location within a user's physical environment, the system comprising;
a) A portable computing device, said portable computing device comprising;
i. an aiming portion, the aiming portion being aimable by a user in the direction of said distant location within said physical environment;
ii. an orientation sensor operative to provide orientation data representing a current physical orientation of said aiming portion within said physical environment;
iii. a locative sensor operative to provide positional data representing a current physical location of said portable computing device within said physical environment;
iv. a user manipulatable trigger operative to provide a signal indicating a user manipulation of said user manipulatable trigger;
v. a CPU able to load and execute software from a memory; said CPU operatively connected to said orientation sensor, said locative sensor, and said user manipulatable trigger, said CPU operative to compute locative coordinates representing said distant location, said CPU computing said locative coordinates based upon said positional data, said orientation data, and a distance offset value that represents a distance from said portable computing device to said distant location, said CPU sending a representation of said locative coordinates to a remote server over a communication link; said CPU receiving data back from said remote server in response to said locative coordinates having been sent and outputting a representation of said data having been received upon at least one of a visual and an aural display;
b) A remote server having access to a plurality of pieces of information, each of said pieces of information being relationally associated with one or more physical locations, said remote server receiving said locative coordinates from said portable computing device over said communication link and in response accessing one or more pieces of information that are relationally associated with said distant location and sending corresponding data back to said portable computing device in response to said locative coordinates.

2. A system as recited in claim 1 wherein said CPU computes said locative coordinates and/or sends said representation of said locative coordinates to said remote server in response to a signal received from said user manipulatable trigger.

3. A system as recited in claim 1 wherein said distance offset value is determined at least in part upon data from a distance determining sensor operationally connected to said CPU.

4. A system as recited in claim 1 wherein said distance offset value is determined at least in part upon a signal from a finger manipulatable object upon said portable computing device.

5. A system as recited in claim 1 wherein said distance offset value is determined at least in part based upon a range of values stored in memory of said portable computing device.

6. A system as recited in claim 1 wherein said distance offset value is determined at least in part based upon input from a user of said portable computing device.

7. A system as recited in claim 1 wherein said orientation sensor is a magnetometer.

8. A system as recited in claim 1 wherein said locative sensor is a GPS transducer.

9. A system as recited in claim 1 wherein said representation of said locative coordinates define a spatial area around said distant location.

10. A system as recited in claim 1 wherein said communication link includes the Internet, said remote server being accessible over said Internet.

11. A system as recited in claim 1 wherein said aiming portion includes a laser pointer for assisting the user in aiming at said distant location.

12. A system as recited in claim 1 wherein said aiming portion includes a camera, the image from said camera being displayed upon a display of said portable computing device for assisting the user in aiming at said distant location.

13. A system as recited in claim 1 wherein said distance offset value is determined at least in part upon input from the user of said portable computing device.

14. A system as recited in claim 4 wherein said finger manipulatable object is one of a roller, a knob, a wheel, or a dial.

15. A system for retrieving information that is relationally associated with a distant location within a user's physical environment, the system comprising;
a) A portable computing device, said portable computing device comprising;
i. an aiming portion, the aiming portion being aimable by a user in the direction of said distant location within said physical environment;
ii. an orientation sensor operative to provide orientation data representing the current physical orientation of said aiming portion within said physical environment;
iii. a locative sensor operative to provide positional data representing the current physical location of said portable computing device within said physical environment;
iv. a user manipulatable trigger operative to provide a signal indicating a user manipulation of said trigger;
v. a CPU operatively connected to said orientation sensor, said locative sensor, and said trigger, said CPU sending a representation of said positional data, said orientation data, and a distance offset value to a remote server over a communication link; said CPU receiving information back from said remote server in response to said sent data and displaying a representation of said received information upon a visual and/or aural display component of said portable computing device;
b) A remote server having access to a plurality of pieces of information, each of said pieces of information being relationally associated with one or more physical locations, said remote server receiving a representation of said positional data, said orientation data, and said distance offset value from said portable computing device over said communication link, computing one or more values based upon said positional data, said orientation data, and said distance offset value, and in response to said one or more computed values, accessing one or more pieces of information that are relationally associated with said distant location and sending said accessed information back to said portable computing device.

16. A system as recited in claim 15 wherein said distance offset value is determined at least in part upon data from a distance determining sensor upon said portable computing device, said sensor aimed in direction of said aiming portion.

17. A method for retrieving information that is relationally associated with a distant location within a user's physical environment, the method comprising:
a. providing a portable computing device with a user aiming portion
b. determining the spatial orientation of said portable computing device at a moment in time when said user aiming portion is aimed by said user at said distance location within said physical environment;
c. determining the geospatial position of said portable computing device within said physical environment at said moment in time;
d. computing locative coordinates representing said distant location, said locative coordinates computed based upon said spatial orientation, said geospatial position, and a distance offset value that represents a distance from said portable computing device to said distant location,
e. accessing information from a remote server using a representation of said computed locative coordinates, said information being relationally associated with said distant location;
f. displaying a representation of said accessed information upon a display component of said portable computing device.

18. A method as recited in claim 17 wherein said accessed information is selected from a plurality of pieces of information that are relationally associated with said distant location, said accessed information selected at least in part upon user defined parameters.

19. A method as recited in claim 17 wherein said user defined parameters include at least one of a Targeting Context or a Targeting Object Type.

20. A method as recited in claim 17 wherein said distance offset value is determined at least in part based upon input from said user.

21. A method as recited in claim 17 wherein said input from said user is provided through a user manipulatable knob, roller, a wheel, or dial upon said portable computing device.

22. A method as recited in claim 17 wherein said computing locative coordinates and/or said accessing information from said remote server is performed in response to said user engaging a physical trigger.

23. A method as recited in claim 17 wherein said aiming portion includes a laser pointer for aiding said user in aiming at said distant location.

24. A method as recited in claim 17 wherein said aiming portion includes a camera pointer for aiding said user in aiming at said distant location.

25. A method as recited in claim 17 wherein said distant location is a circular area within said user's physical environment.

26. A method as recited in claim 25 wherein the size of said circular area is determined at least in part upon input from said user.
